(19) United States
(12) Patent Application Publication
(10) Pub. No.: US 2026/0302289 A1
(43) Pub. Date: Oct. 1, 2026

(54) METHOD FOR OPERATING AN ELECTROCHEMICAL DEVICE, OPEN-LOOP OR CLOSED-LOOP CONTROL DEVICE, AND ELECTROCHEMICAL DEVICE

(71) Applicant: Robert Bosch GmbH, Stuttgart (DE)

(72) Inventors: Sebastian Egger, Radolfzell Am Bodensee (DE); Maxime Carre, Stuttgart (DE); Sebastian Schmaderer, Stuttgart (DE)

(21) Appl. No.: 19/100,950

(22) PCT Filed: Sep. 14, 2023
(86) PCT No.: PCT/EP2023/075223

§ 371 Date: Feb. 4, 2025

(30) Foreign Application Priority Data
Sep. 19, 2022 (DE) 10 2022 209 836.6

(51) Int. Cl. H01M 8/0432; H01M 8/04992

(52) U.S. Cl. CPC H01M 8/04335; H01M 8/04992

(57) ABSTRACT

A method for operating an electrochemical device, in particular a fuel cell device. In at least one method step, at least one operating parameter and at least one further operating parameter, which is different from the operating parameter, are measured for open-loop or closed-loop control of the electrochemical device, and wherein, in at least one method step, it is determined that a steady operating state of the electrochemical device has been reached. A time profile of an, in particular individual, operating characteristic variable combining the at least one operating parameter and the at least one further operating parameter is evaluated in order to identify that the steady operating state has been reached.

### BACKGROUND INFORMATION

A method for operating an electrochemical device, in particular a fuel cell device, has already been proposed in the related art, in which, in at least one method step, at least one operating parameter and at least one further operating parameter, which is different from the operating parameter, are measured for open-loop or closed-loop control of the electrochemical device, and wherein, in at least one method step, it is determined that a steady operating state of the electrochemical device has been reached.

### SUMMARY

The present invention proceeds from a method for operating an electrochemical device, in particular a fuel cell device, wherein, in at least one method step, at least one operating parameter and at least one further operating parameter, which is different from the operating parameter, are measured for open-loop or closed-loop control of the electrochemical device, and wherein, in at least one method step, it is determined that a steady operating state of the electrochemical device has been reached.

According to an example embodiment of the present invention, it is provided that a time profile of an, in particular individual, operating characteristic variable combining the at least one operating parameter and the at least one further operating parameter is evaluated in order to identify that the steady operating state has been reached. The electrochemical device preferably comprises at least one electrochemical conversion unit for electrochemically converting at least one reactant fluid into at least one product fluid. Particularly preferably, the electrochemical conversion unit comprises at least one fuel cell for electrochemically converting a fuel, in particular hydrogen and/or natural gas, with the addition of oxygen and the provision of electrical energy. Preferably, the at least one fuel cell converts an oxygen-containing fluid as a reactant fluid into an oxygen-poor exhaust gas as a product fluid. Preferably, the at least one fuel cell converts the fuel as a further reactant fluid into a fuel-poor exhaust gas as a further product fluid. The terms “fuel-poor” and “oxygen-poor” refer to a content of fuel and oxygen, respectively, in the corresponding product fluid relative to the corresponding reactant fluid. Alternatively, the electrochemical conversion unit comprises at least one electrolyzer, for example for splitting water as a reactant fluid into hydrogen and oxygen as product fluids with the absorption of electrical energy. The electrochemical device preferably comprises at least one sensor unit for measuring the operating parameter and/or the further operating parameter.

For example, the sensor unit measures an electrical parameter of the electrochemical conversion unit, a thermal parameter of the electrochemical conversion unit, of the product fluid and/or of the reactant fluid, a flow parameter of the product fluid and/or of the reactant fluid, or the like as an operating parameter and/or as a further operating parameter. The electrical parameter is, for example, an electrical current provided or absorbed by the electrochemical conversion unit and/or an electrical power provided or absorbed by the electrochemical conversion unit and/or an electrical voltage applied to the electrochemical conversion unit. The thermal parameter is, for example, a temperature or heat quantity of the reactant fluid upon entering the electrochemical conversion unit or a temperature or heat quantity of the product fluid upon exiting the electrochemical conversion unit. The flow parameter is, for example, a volume flow, a molar flow, a particle flow, or a mass flow of the product fluid or of the reactant fluid, a pressure or a pressure difference within the reactant fluid or the product fluid, or the like.

According to an example embodiment of the present invention, preferably, an open-loop or closed-loop control device of the fuel cell device ascertains the operating characteristic variable depending on the operating parameter and depending on the further operating parameter, in particular depending on more than two operating parameters. The operating characteristic variable preferably depends on an overall state of the electrochemical device. Particularly preferably, the operating characteristic variable depends on at least one electrical operating parameter, on at least one thermal operating parameter, and/or on at least one flow parameter of the electrochemical device. Particularly preferably, the operating characteristic variable is a physical and/or chemical variable or characteristic number, for example an electrical voltage, a temperature, an energy, or the like. Alternatively, the operating characteristic variable is an abstract function without physical-chemical meaning, for example a result of a scoring system. Particularly preferably, the open-loop or closed-loop control device evaluates only the operating characteristic variable and, in particular depending on a design of the method, possibly a time in order to decide whether the electrochemical device is in a steady or unsteady operating state. Particularly preferably, the open-loop or closed-loop control device identifies the steady operating state by the fact that the operating characteristic variable changes only insignificantly. In particular, the open-loop or closed-loop control device identifies an unsteady operation by the fact that the operating characteristic variable changes significantly. The open-loop or closed-loop control device preferably ascertains a significant change and/or an insignificant change in the operating characteristic variable by comparing a change variable characterizing or describing the time profile of the operating characteristic variable with a threshold value. The change variable can be designed, for example, as a differential, as a difference quotient, as a difference between consecutively ascertained values of the operating characteristic variable, in particular as a measure of dispersion, or the like. Preferably, the open-loop or closed-loop control device ascertains a plurality of values of the operating characteristic variable within a time window. Particularly preferably, the open-loop or closed-loop control device ascertains values of the operating characteristic variable continuously, in particular at predetermined regular time intervals or in real time. “Real time” is to be understood here as time intervals limited only by the data processing speed of the open-loop or closed-loop control device. Alternatively, the open-loop or closed-loop control device limits ascertainment of a value of the operating characteristic variable to one in 10 milliseconds, in particular to one in 50 milliseconds. Particularly preferably, the open-loop or closed-loop control device ascertains at least one value of the operating characteristic variable in 10 minutes, preferably at least one value of the operating characteristic variable per minute, particularly preferably at least one value of the operating characteristic variable in 10 seconds, most preferably at least one value of the operating characteristic variable per second. The open-loop or closed-loop control device preferably ascertains the change variable depending on multiple values, preferably the majority of the values, in particular all values of the operating characteristic variable that are ascertained within the time window. Optionally, the open-loop or closed-loop control device excludes individual values of the operating characteristic variable that are ascertained within the time window, from further processing into the change variable, for example due to a plausibility check or the like. The open-loop or closed-loop control device preferably ascertains the change variable depending on more than three, particularly preferably more than five, particularly preferably more than ten, values of the operating characteristic variable, which were in particular ascertained at different points in time within the time window.

According to an example embodiment of the present invention, the open-loop or closed-loop control device is preferably designed to bring about the steady operating state by changing the operating parameters. In particular, in the unsteady operating state or when the operating point changes, the open-loop or closed-loop control device actuates at least one actuating unit of the electrochemical device in order to change at least one of the operating parameters and/or one additional, unmonitored operating parameter of the electrochemical device. The actuating unit is, for example, a conveying unit, in particular a pump, a compressor, a blower, or the like, for adjusting the flow parameter and/or the thermal parameter. The actuating unit is, for example, an inverter or an adjustable resistor for adjusting the electrical parameter. Preferably, the open-loop or closed-loop control device changes to a monitoring and/or analysis mode when the steady operating state is reached. The monitoring and/or analysis mode is preferably provided to maintain the steady operating state and optionally to evaluate an actual value of at least one of the operating parameters in the steady operating state for an operational analysis of the electrochemical device, for example for analyzing the reactant fluid, for detecting a degradation of the electrochemical conversion unit, for measuring an efficiency of the electrochemical device, or the like.

Due to the design according to the present invention, a steady operating state can advantageously be easily identified. In particular, it is not necessary to determine a plurality of criteria, threshold values, time constants, or the like for each individual operating parameter. Furthermore, a waiting time after a load change to ensure that a steady operating state is present can advantageously be kept short. In particular, during a load change, it is possible to wait specifically on the steady operating state to be reached. This allows for advantageously robust system dynamics. The method is advantageously robust and at the same time advantageously simple to implement and allows simple interpretation of the operating characteristic variable. Furthermore, extended open-loop and closed-loop control functions as well as soft sensor concepts, which are based, for example, on energy balances and are therefore only valid in the steady operating state, can advantageously be implemented reliably. In particular, this provides an advantageously comprehensive possibility for analyzing a behavior of the electrochemical device. Furthermore, an advantageously high storage and computing efficiency of the open-loop or closed-loop control device can be achieved since a combined variable instead of a plurality of individual operating parameters is included in the monitoring.

It is furthermore provided according to an example embodiment of the present invention that the operating characteristic variable combines at least one electrical parameter, one flow parameter, and one thermal parameter of the electrochemical device as operating parameters in order to identify that the steady operating state has been reached. Particularly preferably, the open-loop or closed-loop control device ascertains the operating characteristic variable, in particular without an additional sensor, depending on standard sensor data of the sensor unit, which are measured for open-loop or closed-loop control of the electrochemical device. For example, the open-loop or closed-loop control device ascertains the operating characteristic variable K using the following calculation rule:

$$K = [ {\dot{n}}_{i n} ( {h}_{out} - {h}_{i n} ) - {h}_{out} \frac{{I}_{e l} {N}_{c e l l s}}{4 \cdot F} + {I}_{e l} {U}_{c e l l s} {N}_{c e l l s} ] \cdot {( {I}_{e l} {N}_{c e l l s} )}^{- 1}$$

where Iₑₗ denotes the electric current generated by the electrochemical conversion unit, U_{cells} denotes an electrical voltage of the electrochemical conversion unit that is linked to the generated current Iₑₗ, N_{cells} denotes the number of fuel cells or electrolyzers in the electrochemical conversion unit, where F denotes the Faraday constant, hₒᵤₜ denotes a molar enthalpy of the product fluid upon exiting the electrochemical conversion unit, hᵢₙ denotes a molar enthalpy of the reactant fluid upon entering the electrochemical conversion unit, and \dot{n}ᵢₙ denotes a material flow of the reactant fluid. The electrical parameters, i.e., the current Iₑₗ and the electrical voltage U_{cells}, are preferably measured by the sensor unit. The flow parameter, i.e., the material flow him, is preferably measured by the sensor unit or ascertained from a volume flow or mass flow measured by the sensor unit. The molar enthalpies hₒᵤₜ, hᵢₙ are ascertained by the open-loop or closed-loop control device, preferably depending on a temperature of the reactant fluid or of the product fluid that is measured by the sensor unit. Regression functions for the molar enthalpies hₒᵤₜ, hᵢₙ are preferably stored depending on the temperature of the reactant fluid or of the product fluid in a memory of the open-loop or closed-loop control device and are used by the open-loop or closed-loop control device to ascertain the molar enthalpies hₒᵤₜ, hᵢₙ. Preferably, the open-loop or closed-loop control device uses the oxygen-containing fluid as a reactant fluid and the oxygen-poor exhaust gas as a product fluid in order to ascertain the operating characteristic variable. Due to the design according to the present invention, relevant operating parameters can advantageously be physically linked for assessing an operating state of the electrochemical device. In particular, a single physically interpretable variable can be used to monitor the operating state. Parameterization of criteria allowing the operating state to be deduced from the operating characteristic variable must only be created for the one operating characteristic variable and not for each operating parameter.

According to an example embodiment of the present invention, it is furthermore provided that, in at least one method step of the method, a measure of dispersion of the operating characteristic variable is evaluated in order to identify that the steady operating state has been reached. The open-loop or closed-loop control device preferably evaluates the values of the operating characteristic variable that were ascertained in the time window, in order to ascertain the measure of dispersion. The time window is preferably a sliding time window. The open-loop or closed-loop control device preferably updates the time window regularly, in particular with each newly ascertained value of the operating characteristic variable. The measure of dispersion used can, for example, be the sum of the squared deviations, the empirical variance, the empirical standard deviation, the coefficient of variation, the mean absolute deviation from a mean value, a quantile distance, or the like of the values of the operating characteristic variable that were ascertained in the time window. The mean value of the operating characteristic variable can refer to the arithmetic mean, the geometric mean, the median, or another mean of the operating characteristic variable. Preferably, the open-loop or closed-loop control device evaluates an ascertained value of the measure of dispersion in order to decide, in particular independently of the mean value of the operating characteristic variable, whether the electrochemical device is in a steady operating state or in an unsteady operating state. Preferably, the open-loop or closed-loop control device decides that the electrochemical device is in a steady operating state, if the measure of dispersion is less than a threshold value. The threshold value can be defined absolutely or relatively to the mean value. Preferably, the open-loop or closed-loop control device decides that the electrochemical device is in an unsteady operating state, if the measure of dispersion is greater than the threshold value or a further threshold value, which is different from the threshold value. Alternatively, the open-loop or closed-loop control device evaluates the operating characteristic variable by means of a wavelet transform in order to identify that the steady operating state has been reached. Due to the design according to the present invention, a time profile of the operating characteristic variable can advantageously be easily evaluated.

According to an example embodiment of the present invention, it is furthermore provided that, in at least one method step of the method, the empirical variance of the operating characteristic variable is used as a measure of dispersion. The empirical variance can be ascertained as the sum of the squared deviations divided by the number of degrees of freedom (corrected empirical variance) or divided by the number of values in the time window (uncorrected empirical variance). Due to the design according to the present invention, a time profile of the operating characteristic variable can advantageously be easily evaluated.

According to an example embodiment of the present invention, it is furthermore provided that at least two values of the operating characteristic variable that are included in a decision as to whether the steady operating state is present or not are more than 10 minutes apart. The time window can be defined directly via the time duration, in particular if the values of the operating characteristic variable are provided and stored with a time stamp, and/or via a number of values of the operating characteristic variable, in particular if these values are measured at regular time intervals. Preferably, the time window comprises at least 10 minutes, preferably at least 20 minutes, particularly preferably at least 30 minutes. Preferably, the open-loop or closed-loop control device stores all ascertained values of the operating characteristic variable in the time window. Preferably, the open-loop or closed-loop control device stores at most a predetermined maximum number of values of the operating characteristic variable, which number is preferably defined by the time window. When the maximum number of values of the reference characteristic variable is reached, one stored value of the operating characteristic variable is replaced for each newly ascertained value of the operating characteristic variable, preferably according to the first in, first out (FIFO) principle. Due to the design according to the present invention, an assessment of whether the operating state is steady or unsteady can preferably be carried out reliably.

According to an example embodiment of the present invention, it is furthermore provided that, in at least one method step of the method, an exponentially smoothed average of the operating characteristic variable is ascertained. Preferably, the open-loop or closed-loop control device ascertains the mean value of the operating characteristic variable as an exponentially smoothed average based on all values ascertained in the time window. Preferably, the open-loop or closed-loop control device ascertains the measure of dispersion depending on the exponentially smoothed average. Preferably, the open-loop or closed-loop control device updates the measure of dispersion recursively. Preferably, the open-loop or closed-loop control device ascertains, for each newly ascertained value Kᵢ of the operating characteristic variable, a deviation δᵢ of the newly ascertained value of the operating characteristic variable from a previous value of the exponentially smoothed average K_{ema,i-1}, in particular in accordance with

$${δ}_{i} = {K}_{i} - {K}_{ema , i - 1}$$

Preferably, according to an example embodiment of the present invention, the open-loop or closed-loop control device updates the exponentially smoothed average K_{ema,i} by adding the deviation δᵢ of the newly ascertained value of the operating characteristic variable Kᵢ to the previous value of the exponentially smoothed average K_{ema,i-1}, wherein a smoothing factor α is applied to the deviation, in particular in accordance with

$${K}_{ema , i} = α \cdot {δ}_{i} + {K}_{ema , i - 1}$$

Preferably, according to an example embodiment of the present invention, the open-loop or closed-loop control device ascertains an updated value of the measure of dispersion var(K)_{ema,i} depending on the smoothing factor α, a previous value of the measure of dispersion var(K)_{ema,i-1}, and the deviation δᵢ of the newly ascertained value of the operating characteristic variable, in particular in accordance with

$${var ( K )}_{ema , i} = ( 1 - α ) \cdot ( {var ( K )}_{ema , i - 1} + α \cdot {δ}_{i}^{2} )$$

The smoothing factor is preferably between 0 and 1. Preferably, the open-loop or closed-loop control device ascertains an initial value of the measure of dispersion var(K)_{ema,0} non-recursively, in particular by means of an explicit form of the measure of dispersion, such as the sum of the squared deviations. The open-loop or closed-loop control device can use the arithmetic mean, the geometric mean, the median of the values of the operating characteristic variable in the time window, a specific value of the ascertained values of the operating characteristic variable, for example the first value, the last value, or the like, or a randomly selected value of the operating characteristic variable as the initial value of the operating characteristic variable K_{ema,0}. Due to the design according to the present invention, a memory consumption and/or a necessary computing power of the open-loop or closed-loop control device for identifying the steady operating state can advantageously be kept small.

According to an example embodiment of the present invention, it is furthermore provided that, in at least one method step of the method, a smoothing factor for ascertaining the exponentially smoothed average is selected depending on a relaxation time of the electrochemical device. The time window is preferably longer than the relaxation time of the electrochemical device. Preferably, the smoothing factor is ascertained depending on a ratio of the relaxation time to the duration of the time window. The relaxation time of the electrochemical device depends on a heat capacity of the electrochemical conversion unit and indicates in particular how quickly a temperature of the electrochemical conversion unit approaches a new equilibrium temperature, in particular exponentially, when the steady operating state is left intentionally or due to a disturbance. Due to the design according to the present invention, a ratio of a significance of past values and current values of the operating characteristic variable in the exponentially smoothed average can be advantageously linked to a dynamic relevant to the electrochemical device.

According to an example embodiment of the present invention, it is furthermore proposed that, in at least one method step of the method, the time profile of the operating characteristic variable until the steady operating state is reached is evaluated for a state assessment of the electrochemical device. The state assessment may, for example, include a fault analysis, a service life forecast, and/or a determination of a degree of degradation of the electrochemical device by the open-loop or closed-loop control device or an external computing unit. Preferably, when the steady state is identified, the open-loop or closed-loop control device outputs a signal that the steady state has been reached, so that a state assessment dependent on a steady state can be started by the external computing unit. Additionally or alternatively, the open-loop or closed-loop control device directly evaluates the time profile of the operating characteristic variable in order to carry out a state assessment. For example, the open-loop or closed-loop control device or the external computing unit ascertains a duration until the steady operating state is reached, an amplitude of an overshoot or an asymptotic creep behavior of the operating characteristic variable, a damping of the amplitude of the overshoot of the operating characteristic variable, a mean value of the operating characteristic variable when the steady operating state is reached, or the like. Alternatively or additionally, the open-loop or closed-loop control device stores and/or sends the time profile of the operating characteristic variable for evaluation by a maintenance technician and/or an external computing device, for example a server on which a machine learning process for state assessment has been implemented. The design according to the present invention advantageously provides many additional parameters for a state assessment. Furthermore, a starting time of the state assessment can advantageously be reliably selected in the steady operating state.

Furthermore, an open-loop or closed-loop control device for an electrochemical device for carrying out a method according to the present invention is provided. The open-loop or closed-loop control device is provided for open-loop or closed-loop control of the electrochemical device. According to an example embodiment of the present invention, the open-loop or closed-loop control device is preferably a unit with at least one electronic open-loop control system. An “electronic open-loop control system” is in particular to be understood as a unit having a processor unit and having a memory, and having an operating program stored in the memory. The design according to the present invention makes it possible to provide an open-loop or closed-loop control device that can advantageously identify a steady operating state reliably with an advantageously low memory and/or computing requirement.

Furthermore, an electrochemical device, in particular a fuel cell device, with at least one electrochemical conversion unit and with at least one open-loop or closed-loop control device according to the present invention is provided. According to an example embodiment of the present invention, the electrochemical conversion unit preferably comprises at least one fuel cell or one electrolyzer, preferably a stack of, in particular structurally identical, fuel cells or electrolyzers or a combination of multiple stacks of, in particular structurally identical, fuel cells or electrolyzers. The at least one fuel cell is preferably designed as a high-temperature fuel cell, in particular a solid oxide fuel cell or a molten carbonate fuel cell. Alternatively, the fuel cell is a phosphoric acid fuel cell, a direct methanol fuel cell, or a polymer electrolyte membrane fuel cell. The at least one electrolyzer is preferably designed as a high-temperature electrolyzer, in particular as a solid oxide electrolyzer cell.

According to an example embodiment of the present invention, preferably, the electrochemical device comprises at least one reactant fluid conveying unit or one reactant fluid shut-off device for adjusting a flow rate of fresh reactant fluid to the electrochemical conversion unit. The reactant fluid conveying unit or the reactant fluid shut-off device are preferably actuated by the open-loop or closed-loop control device for adjusting the steady operating state. The electrochemical device preferably comprises at least one inverter and/or one adjustable resistor for adjusting the electrical parameter. The inverter and/or the adjustable resistor are preferably actuated by the open-loop or closed-loop control device for adjusting the steady operating state. The electrochemical device preferably comprises the sensor unit for measuring the operating parameters of the electrical device. The sensor unit comprises, for example, at least one temperature sensor upstream of the electrochemical conversion unit. The sensor unit comprises, for example, at least one further temperature sensor downstream of the electrochemical conversion unit and/or in or on the electrochemical conversion unit. The sensor unit comprises, for example, an ammeter and/or a voltmeter for measuring the electrical parameter. The sensor unit preferably comprises at least one flow meter for measuring the flow parameter.

In particular, when designed as a fuel cell device, the electrochemical device optionally comprises an afterburner for utilizing fuel residues in the fuel-poor exhaust gas, a desulfurizer and/or a reformer for processing the fuel, a heat exchanger for transferring heat from a product fluid to the reactant fluid, and/or a recirculation line for feeding the product fluid back into the reactant fluid.

The design according to the present invention makes it possible to provide an electrochemical device whose operating state can be ascertained during operation of the electrochemical device advantageously promptly, in particular in real time, advantageously reliably, and advantageously in a resource-saving manner.

The method according to the present invention, the open-loop or closed-looped control device according to the present invention, and the electrochemical device according to the present invention are not to be limited to the application and embodiment described above. In particular, for fulfilling a functionality described here, the method according to the present invention, the open-loop or closed-loop control device according to the present invention, and the electrochemical device according to the present invention may have a number of individual elements, components, units, and method steps that deviates from a number mentioned here. In addition, in the case of the value ranges specified in this disclosure, values within the mentioned limits are also to be considered as disclosed and usable as desired.

### BRIEF DESCRIPTION OF THE DRAWINGS

Further advantages result from the following description of the figures. An exemplary embodiment of the present invention is illustrated in the figures. The disclosure herein contain numerous features in combination. A person skilled in the art will expediently also consider the features individually and combine them to form meaningful further combinations.

FIG. 1 shows a schematic representation of an electrochemical device according to an example embodiment of the present invention.

FIG. 2 shows a schematic flowchart of a method according to an example embodiment of the present invention.

### DETAILED DESCRIPTION OF EXAMPLE EMBODIMENTS

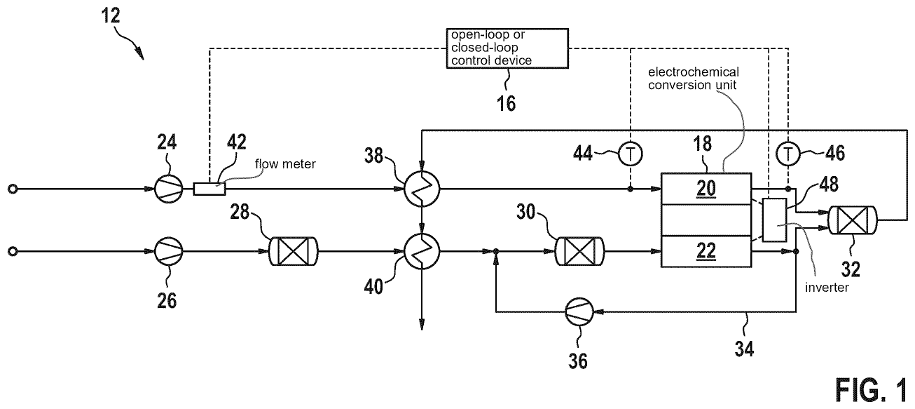

FIG. 1 shows an electrochemical device 12. The electrochemical device 12 is designed, for example, as a fuel cell device. The electrochemical device 12 preferably comprises at least one electrochemical conversion unit 18. The electrochemical conversion unit 18 comprises at least one fuel cell, preferably a plurality of fuel cells, which are particularly preferably arranged in at least one stack. For the sake of clarity, the electrochemical conversion unit 18 is shown here functionally as a single fuel cell. The electrochemical conversion unit 18, in particular each fuel cell of the electrochemical conversion unit 18, comprises at least one oxygen electrode 20 and at least one fuel electrode 22. The oxygen electrode 20 is provided for direct contact with an oxygen-containing fluid as a reactant fluid. The oxygen electrode 20 preferably outputs an oxygen-poor exhaust gas as a product fluid. The fuel electrode 22 is provided for direct contact with a fuel as a further reactant fluid. The fuel electrode 22 preferably outputs a fuel-poor exhaust gas as a further product fluid. The electrochemical device 12 preferably comprises an inverter 48, which is electrically connected to the oxygen electrode 20 and to the fuel electrode 22.

Particularly preferably, the at least one fuel cell, in particular all fuel cells of the electrochemical conversion unit 18, is designed as a solid oxide fuel cell (SOFC).

The electrochemical device 12 preferably comprises a reactant fluid conveying unit 24, in particular a fan, a blower, or a compressor, for conveying the oxygen-containing fluid to the oxygen electrode 20. The oxygen-containing fluid is particularly preferably ambient air, which is sucked in by the reactant fluid conveying unit 24. Alternatively, the oxygen-containing fluid is an industrial gas with a defined oxygen content. The reactant fluid delivery unit 24 is arranged upstream of the oxygen electrode 20 with respect to the oxygen-containing fluid.

The electrochemical device 12 preferably comprises a further reactant fluid conveying unit 26, in particular a fan, a blower, or a compressor, for conveying the fuel to the fuel electrode 22. The fuel is preferably hydrogen and/or natural gas. Alternatively, the fuel comprises at least one hydrocarbon as a pure substance or as a mixture, and/or ammonia. The further reactant fluid conveying unit 26 is arranged upstream of the fuel electrode 22 with respect to the fuel. The electrochemical conversion unit 18 is preferably provided for providing electrical energy to convert the fuel into the further product fluid with the addition of oxygen from the oxygen-containing fluid.

Optionally, the electrochemical device 12 comprises a desulfurizer 28. The desulfurizer 28 is preferably arranged downstream of the further reactant fluid conveying unit 26 and upstream of the electrochemical conversion unit 18 with respect to the further reactant fluid. Optionally, the electrochemical device 12 comprises a reformer 30 for reforming the further reactant fluid. The reformer 30 is preferably arranged downstream of the further reactant fluid conveying unit 26, in particular downstream of the desulfurizer 28, and upstream of the electrochemical conversion unit 18 with respect to the further reactant fluid.

The electrochemical device 12 preferably comprises a recirculation line 34 and a recirculation conveying unit 36, in particular a fan, a blower, or a compressor, arranged in particular in or on the recirculation line 34, for feeding the further product fluid exiting the fuel electrode 22 back into the further reactant fluid upstream of the fuel electrode 22. A feed opening of the recirculation line 34 is preferably arranged upstream of the reformer 30 and downstream of the desulfurizer 28 with respect to the further reactant fluid.

The electrochemical device 12 preferably comprises an afterburner 32 for converting fuel residues contained in the further product fluid. The afterburner 32 is preferably arranged downstream of the fuel electrode 22 and in particular downstream of a branching point into the recirculation line 34 with respect to the further product fluid. The afterburner 32 is preferably arranged downstream of the oxygen electrode 20 with respect to the product fluid. Preferably, the electrochemical device 12 comprises a heat exchanger 38 for transferring heat from an afterburner exhaust gas of the afterburner 32 exiting the afterburner 32 to the reactant fluid upstream of the electrochemical conversion unit 18. The heat exchanger 38 is preferably arranged downstream of the reactant fluid conveying unit 24 and upstream of the electrochemical conversion unit 18 with respect to the reactant fluid. Preferably, the electrochemical device 12 comprises a further heat exchanger 40 for transferring heat from the afterburner exhaust gas of the afterburner 32 exiting the afterburner 32 to the further reactant fluid upstream of the electrochemical conversion unit 18. The further heat exchanger 40 is preferably arranged downstream of the desulfurizer 28 and upstream of the feed opening of the recirculation line 34 with respect to the further reactant fluid. The further heat exchanger 40 is arranged here, by way of example, downstream of the heat exchanger 38 with respect to the afterburner exhaust gas. Alternatively, the heat exchanger 38 is arranged downstream of the further heat exchanger 40 with respect to the afterburner exhaust gas.

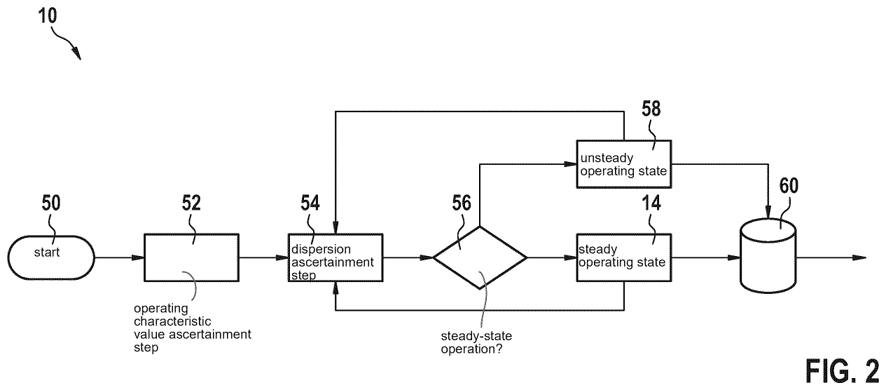

The electrochemical device 12 comprises at least one open-loop or closed-loop control device 16. The open-loop or closed-loop control device 16 is preferably provided for actuating the reactant fluid conveying unit 24, the further reactant fluid conveying unit 26, the recirculation conveying unit 36 in order to adjust a flow parameter of the reactant fluid and/or of the further reactant fluid through the electrochemical conversion unit 18. The open-loop or closed-loop control device 16 is preferably provided for actuating the inverter 48 in order to adjust an electrical parameter of the electrochemical conversion unit 18. The open-loop or closed-loop control device 16 is provided for carrying out a method 10, which is explained in more detail in the following FIG. 2.

The electrochemical device 12 comprises at least one sensor unit. The sensor unit preferably comprises a flow meter 42 for measuring the flow parameter of the reactant fluid. The flow meter 42 is preferably arranged downstream of the reactant fluid conveying unit 24 and upstream of the electrochemical conversion unit 18, in particular the heat exchanger 38. Alternatively, the open-loop or closed-loop control device 16 ascertains the flow parameter from a conveying capacity, in particular a rotational speed, of the reactant fluid conveying unit 24. The sensor unit preferably comprises at least one inlet temperature sensor 44 for measuring an inlet temperature of the reactant fluid upon entering the electrochemical conversion unit 18. The inlet temperature sensor 44 is preferably arranged upstream of the electrochemical conversion unit 18 and downstream of the reactant fluid conveying unit 24, in particular of the heat exchanger 38. The sensor unit preferably comprises at least one outlet temperature sensor 46 for measuring an outlet temperature of the product fluid upon exiting the electrochemical conversion unit 18. The outlet temperature sensor 46 is preferably arranged downstream of the electrochemical conversion unit 18 and upstream of the afterburner 32. The open-loop or closed-loop control device 16 preferably takes the electrical parameter directly from the inverter 48.

FIG. 2 shows the method 10 for operating the electrochemical device 12. At a start 50 of the method 10, the electrochemical device 12 is preferably put into operation. During the start 50, the open-loop or closed-loop control device 16 preferably selects an operating point of the electrochemical device 12. The method 10 preferably comprises an operating characteristic variable ascertainment step 52. In the operating characteristic variable ascertainment step 52, the open-loop or closed-loop control device 16 ascertains an operating characteristic variable based on operating parameters measured by the sensor unit. In the operating characteristic variable ascertainment step 52 of the method 10, at least one operating parameter and at least one further operating parameter, which is different from the operating parameter, are measured for open-loop or closed-loop control of the electrochemical device 12. Preferably, the sensor unit measures the flow parameter, in particular as volume flow, of the reactant fluid, the inlet temperature of the reactant fluid, the outlet temperature of the product fluid, and the electrical parameter of the electrochemical conversion unit 18, in particular an electrical current provided by the electrochemical conversion unit 18, and an electrical voltage linked to the electrical current, as one of the operating parameters. Preferably, the open-loop or closed-loop control device 16 and the sensor unit carry out the operating characteristic variable ascertainment step 52 continuously.

Preferably, the method 10 comprises a dispersion ascertainment step 54. In the dispersion ascertainment step 54, the open-loop or closed-loop control device 16 evaluates a time profile of the operating characteristic variable combining the at least one operating parameter and the at least one further operating parameter. The open-loop or closed-loop control device 16 ascertains a measure of dispersion of the operating characteristic variable. The open-loop or closed-loop control device 16 ascertains the empirical variance of the operating characteristic variable as a measure of dispersion.

Preferably, the method 10 comprises a dispersion assessment step 56. In the dispersion assessment step 56, the open-loop or closed-loop control device 16 evaluates the measure of dispersion of the operating characteristic variable in order to identify that a steady operating state 14 of the electrochemical device 12 has been reached. In the dispersion assessment step 56, the open-loop or closed-loop control device 16 determines whether a steady operating state 14 of the electrochemical device 12 has been reached or whether the electrochemical device 12 is (still) in an unsteady operating state 58. The open-loop or closed-loop control device 16 preferably determines that the electrochemical device 12 is in the steady operating state 14, if the measure of dispersion is less than a predetermined threshold value. The threshold value can be an absolute value or a value relative to a mean value of the operating characteristic variable. The open-loop or closed-loop control device 16 preferably determines that the electrochemical device 12 is in the unsteady operating state 58, if the measure of dispersion is greater than the predetermined threshold value.

The method 10 preferably comprises a storage step 60. In the storage step 60, the open-loop or closed-loop control device 16 preferably stores the operating characteristic variable and preferably the measure of dispersion. In the operating characteristic variable ascertainment step 52, an exponentially smoothed average of the operating characteristic variable is ascertained, and the measure of dispersion of the exponentially smoothed average of the operating characteristic variable is ascertained in the dispersion ascertainment step 54. A smoothing factor for ascertaining the exponentially smoothed average depends on a relaxation time of the electrochemical device 12. The relaxation time, which is in particular given by a heat capacity of the electrochemical conversion unit 18, can be ascertained in advance of the method 10 and stored in a memory of the open-loop or closed-loop control device 16 or can be ascertained by the open-loop or closed-loop control device 16 by means of a test operation of the electrochemical device 12.

Preferably, the smoothing factor is dependent, in particular proportional, to a ratio of the relaxation time to a duration of a time window which defines a number of values of the operating characteristic variable that are to be taken into account when ascertaining the exponentially smoothed average. At least two values of the operating characteristic variable which are included in a decision as to whether the steady operating state 14 is present or not are more than 10 minutes apart.

Preferably, the open-loop or closed-loop control device 16 ascertains the exponentially smoothed average of the operating characteristic variable and its measure of dispersion recursively depending on the last ascertained value of the operating characteristic variable, on the last ascertained value of the exponentially smoothed average, and on the last ascertained value of the measure of dispersion. Preferably, the last ascertained value of the exponentially smoothed average of the operating characteristic variable is stored in the storage step 60, in particular instead of the last ascertained value of the operating characteristic variable. Alternatively, a predetermined number of values of the operating characteristic variable that are ascertained, in particular all values ascertained in a time window, are collected in the storage step 60 in order to ascertain the measure of dispersion by means of an explicit form of the measure of dispersion.

When the steady operating state 14 is reached, the open-loop or closed-loop control device 16 preferably changes from an operating point control to a monitoring mode and/or outputs an indication signal that the electrochemical device 12 is in the steady operating state 14. After the steady operating state 14 has been reached, the time profile of the operating characteristic variable until the steady operating state 14 is reached is evaluated for a state assessment of the electrochemical device 12 by the open-loop or closed-loop control device 16 or an external computing device. The state assessment can be output by the open-loop or closed-loop control device 16, for example to a maintenance service, and/or further processed for adapting an open-loop or closed-loop control.

1-10. (canceled)

11. A method for operating an electrochemical device including a fuel cell device, the method comprising the following steps:
measuring at least one operating parameter and at least one further operating parameter, which is different from the operating parameter, for open-loop or closed-loop control of the electrochemical device; and
determining that a steady operating state of the electrochemical device has been reached, wherein a time profile of an individual, operating characteristic variable combining the at least one operating parameter and the at least one further operating parameter is evaluated in order to identify that the steady operating state has been reached.

12. The method according to claim 11, wherein the operating characteristic variable combines at least one electrical parameter, one flow parameter, and one thermal parameter of the electrochemical device as operating parameters in order to identify that the steady operating state has been reached.

13. The method according to claim 11, wherein, a measure of dispersion of the operating characteristic variable is evaluated in order to identify that the steady operating state has been reached.

14. The method according to claim 13, wherein an empirical variance of the operating characteristic variable is used as a measure of the dispersion.

15. The method according to claim 11, wherein at least two values of the operating characteristic variable that are included in a decision as to whether the steady operating state is present or not are more than 10 minutes apart.

16. The method according to claim 11, wherein an exponentially smoothed average of the operating characteristic variable is ascertained.

17. The method according to claim 16, wherein a smoothing factor for ascertaining the exponentially smoothed average is selected depending on a relaxation time of the electrochemical device.

18. The method according to claim 11, wherein the time profile of the operating characteristic variable until the steady operating state is reached is evaluated for a state assessment of the electrochemical device.

19. An open-loop or closed-loop control device for an electrochemical device, the control device configured to operate the electrochemical device, the electrochemical device including a fuel cell device, the control device configured to:
measure at least one operating parameter and at least one further operating parameter, which is different from the operating parameter, for open-loop or closed-loop control of the electrochemical device; and
determine that a steady operating state of the electrochemical device has been reached, wherein a time profile of an individual, operating characteristic variable combining the at least one operating parameter and the at least one further operating parameter is evaluated in order to identify that the steady operating state has been reached.

20. An electrochemical device including a fuel cell device, comprising:
at least one electrochemical conversion unit; and
an open-loop or closed-loop control device configured to operate the electrochemical device, the control device configured to:
measure at least one operating parameter and at least one further operating parameter, which is different from the operating parameter, for open-loop or closed-loop control of the electrochemical device, and
determine that a steady operating state of the electrochemical device has been reached, wherein a time profile of an individual, operating characteristic variable combining the at least one operating parameter and the at least one further operating parameter is evaluated in order to identify that the steady operating state has been reached.
